(19) United States
(12) Patent Application Publication
(10) Pub. No.: US 2009/0230330 A1
(43) Pub. Date: Sep. 17, 2009

(54) METHOD OF REPAIRING A SPECIMEN INTENDED TO BE ANALYSED BY ELECTRON MICROSCOPY

(75) Inventor: David COOPER, Grenoble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 12/398,533

(22) Filed: Mar. 5, 2009

(30) Foreign Application Priority Data
Mar. 11, 2008 (FR) 08 51545

(51) Int. Cl. G21K 5/10

(52) U.S. Cl. 250/492.22

(57) ABSTRACT

The invention relates to a method of repairing crystal defects buried within a specimen (10) deriving from a semiconductor device. This specimen (10) is prepared by the use of a focused ion beam that has caused said defects. The method consists in subjecting the specimen (10) to a laser annealing operation, the laser (12) having a power low enough not to melt the semiconductor material of the specimen (10) but high enough to eliminate the defects.

Application to the preparation of specimens that have to be analysed by electron microscopy.

### TECHNICAL FIELD

The present invention relates to the preparation of specimens that have to be analysed by electron microscopy, particularly transmission electron microscopy (TEM) and even more particularly by electron holography. The technique of electron holography, originally conceived by Denis Gabor, is based on the formation of an interference image, or hologram. This electron holography technique, and especially the technique of off-axis electron holography, enables the electron phase lost in the other imaging techniques to be recovered. Thanks to this off-axis electron holography technique, it is possible to measure the local magnetic and electric fields inside and outside a specimen on a nanoscale. In nanoelectronics, this is an incomparable characterization tool. Its principle is the following: a coherent electron source is split into two electron beams. One of the two passes through the specimen to be analysed and the other one, propagating in a vacuum, serves as reference. The two beams arrive on a biprism in such a way that they interfere, since the beams are coherent. An electron hologram is formed at the exit of the biprism. Using the electron hologram, it is possible to obtain, on the one hand, information about the phase of the electron wave and, on the other hand, information about the amplitude of said wave that has given rise to the hologram. This phase information and amplitude information are usually mixed in a conventional electron image and cannot be recovered separately. If the specimen to be analysed is not magnetic, the phase of an electron is proportional to the electrostatic field in the specimen. If the latter is made of a doped semiconductor material, it is possible to obtain a map of the dopants in the specimen with a nanoscale resolution.

The difficulty with this electron holography technique is the preparation of the specimen to be analysed. It is necessary to have a specimen that is very thin, of the order of a few hundred manometers, and that is as transparent as possible to the electrons, at least in the region of interest.

### PRIOR ART

Currently, specimens are prepared by FIB (focused ion beam) milling. It is possible to obtain a specimen with approximately parallel faces with an appropriate site specificity. A gallium ion beam is used to cut the specimen into a semiconductor device, such as a transistor for example. The specimen may then be skimmed, if the ion beam scans the surface of the specimen until the desired thickness, of around 400 nanometres, is achieved. However, the drawback is that the gallium ion beam leads to substantial damage on the specimen. An amorphous surface layer with a large concentration of implanted gallium ions and crystal defects buried depthwise in crystalline regions of the specimen form. The defects in the crystalline regions of the specimen have the effect of trapping dopants. As a consequence, there is a modification in the phase of the dopant map obtained by the scanning which is less than that predicted by theory. The crystalline modification causes electrical defects.

It is therefore necessary to treat the specimen so that, when it is analysed by electron holography, it can be observed without being altered by the defects generated by the focused ion beam milling.

Document [1] (the document references are given at the end of the description) recommends, in order to increase the measured phase signal significantly in holographic images of pn junctions in a specimen obtained by focused ion beam milling, to subject the specimen to a thermal annealing treatment in situ during the electron holography analysis so as to repair the defects. The treatment consists in subjecting the specimen to temperature holds at increasing temperatures for a duration of one hour per temperature hold, each hold being followed by a rest at ambient temperature for half an hour. The dopants in the crystalline structure are reactivated. The inverse of the phase due to a reduction in the electrically inactive layer is measured. The signal-to-noise in the phase image is increased.

Unfortunately, it is noticed that with such a treatment the dopants that are normally in the object from which the specimen has been taken diffuse and that the dopant map obtained by the electron holography is false and not representative of the object from which the specimen was taken.

Document [2] teaches the use of a laser annealing operation to eliminate defects in semiconductor devices into which ions have been implanted during the fabrication of said devices. That document does not describe the treatment of specimens taken from the device.

Document [3] recommends subjecting a silicon specimen doped with boron ions to an excimer laser annealing operation (wavelength 308 nm, with 28 ns pulses), thereby electrically activating the boron ions. Above a laser energy density of 450 mJ/cm², the silicon melts and activation occurs.

Document [4] recommends the use of an excimer laser to continue the thinning of the specimen after it has been thinned by a focused ion beam and to obtain a more satisfactory finish. The characteristics of the laser pulses are such that they break the atomic bonds at the surface or close to the surface of the specimen.

Neither of the last two documents proposes to carry out a repair, but only either to activate the dopants or to obtain a better surface finish.

Document [5] recommends, in order to eliminate the ions implanted during ion milling, subjecting the specimen to a laser annealing operation with the purpose, thanks to the melting, of bringing the implanted ions up to the surface, these being eliminated after cooling, thanks to a chelating agent. The defects in the crystalline structure are not thereby repaired, even if the trapped ions are eliminated. In the above document, the aim is to remove the implanted ions, which do not remain in the specimen.

### SUMMARY OF THE INVENTION

The objective of the present invention is specifically to provide a method that actually repairs the crystal defects contained in a specimen taken from a semiconductor device, said defects being caused by a focused ion beam used to prepare it, without causing diffusion of implanted ions in the specimen and especially of ions that are normally in the semiconductor device from which the specimen was taken.

To achieve this objective, the invention relates more precisely to a method of repairing crystal defects buried within a specimen deriving from a semiconductor device, this specimen having been prepared by the use of a focused ion beam that has caused said defects, in which the specimen is subjected to a laser annealing operation, the laser having a power low enough not to melt the semiconductor material of the specimen but high enough to eliminate the defects.

The power density of the laser is between about 235 and 290 mJ/cm² for a specimen thickness greater than about 300 nm, more particularly greater than about 400 nanometres.

An ultraviolet laser, for example an excimer laser, will be chosen, and the excimer laser may emit pulses with a repetition frequency of 10 Hz and a duration of about 20 ns.

The laser beam will preferably have a diameter of about 700 microns.

The laser will be made to undergo a scanning movement with a pitch of about 350 microns.

In addition, arrangements are made for the laser to irradiate an area of the specimen three times during the scanning.

### BRIEF DESCRIPTION OF THE DRAWINGS

The present invention will be more clearly understood on reading the description of an exemplary embodiment given purely by way of indication and implying no limitation, with reference to the appended drawings in which:

FIG. 1 is a view of a specimen of a semiconductor device obtained by focused ion beam milling and provided with buried crystal defects that it is desired to eliminate; and

FIG. 2 is a set-up for implementing the method of the invention.

The various parts shown in FIG. 2 are not necessarily drawn to a uniform scale, so as to make the figure more legible.

### DETAILED DESCRIPTION OF PARTICULAR EMBODIMENTS

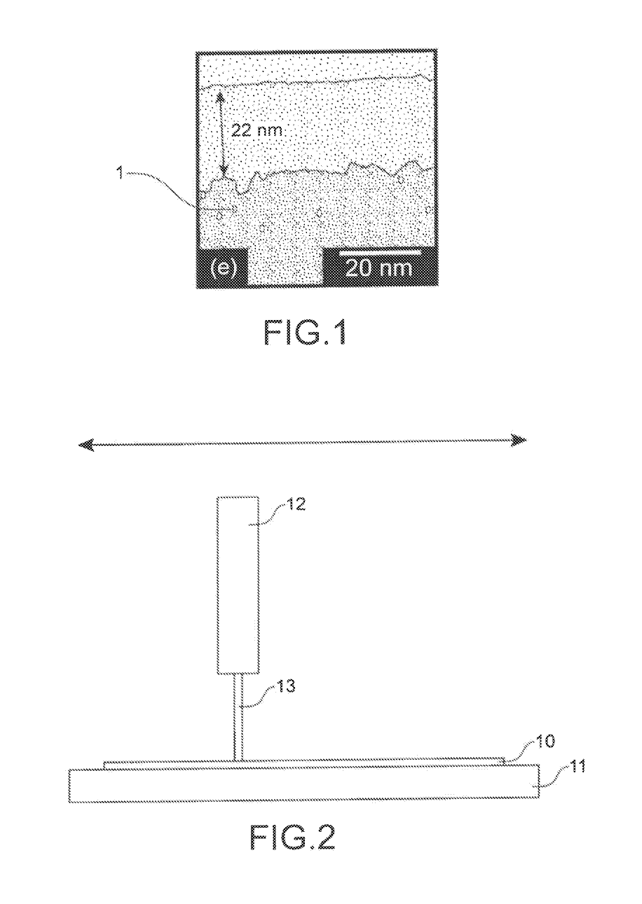

FIG. 1 is an image of a specimen taken from a semiconductor device by focused ion beam milling. The ions used may be Ga⁺ ions, Si⁺ ions, O⁺ ions or Ar⁺ ions. If the implanted ions are Si⁺ ions and the specimen is made of silicon, the implanted ions disappear into the specimen, and there are no impurities that remain.

This image is obtained using an electron microscope operating in transmission mode. If the microscope can be used to carry out electron holography, it is possible to draw up a map of the doped zones of the specimen. It is to this type of specimen that the repair method of the invention applies. This figure shows an amorphous surface layer with a thickness of about 22 nanometres and, beneath the amorphous layer, crystalline semiconductor material containing crystal defects 1 that it is desired to remove by the repair. These defects 1 correspond to the dark areas distributed within the crystalline zone. These defects 1 derive from the interaction between the implanted ions and the atoms of the crystalline semiconductor material of the specimen during focused ion beam milling. The defects are in the crystalline zone and not in the amorphous zone. The amorphous surface layer is not eliminated by the repair method of the invention. This is not a problem as it is possible to limit its thickness by lowering the ion acceleration voltage when taking a specimen.

FIG. 2 shows a specimen 10 of a semiconductor device in the course of being repaired by the method of the invention. The specimen 10 is a part taken from a semiconductor device, for example based on silicon. Other semiconductor materials can be used, such as gallium, silicon-germanium, gallium arsenide, indium phosphide, gallium nitride and SOI (silicon-on-insulator). The semiconductor device may be a transistor and normally comprise one or more doped zones corresponding to pn junctions. These doped zones lying within the semiconductor device before the specimen 10 is taken do not constitute the defects that it is desired to repair.

The defects that it is desired to repair are introduced when the specimen 10 is being prepared and in particular when taking the specimen 10 by focused ion beam milling. However, the defects that it is desired to repair are localized in the doped zones.

The dopants that it is desired to preserve, without them diffusing, are of a different nature to the dopant introduced during ion milling.

The specimen 10 to be repaired rests on a table 11, for example made of glass. A laser 12 is used to subject the specimen 10 to a laser annealing operation. The laser 12 is made to undergo a scanning movement above a main surface of the specimen 10.

The laser transfers energy to the specimen—this energy goes to repair the region in which the crystal defects are located. The energy transfer must be sufficiently rapid so that the repair takes place without any dopant diffusion occurring. The duration of the laser pulses determines the energy transferred to the specimen. For example, it is possible to use an XeCl laser having 20-nanosecond pulses and a power density of 290 mJ/cm².

Any type of laser may be employed in the invention, including a ruby laser, but a person skilled in the art will adapt the power and the pulse duration to the specimen to be treated. For example, the laser 12 may be an ultraviolet laser such as an excimer laser. Excimer lasers are pulsed gas lasers emitting ultraviolet radiation. They emit a beam 13 having a substantially uniform energy distribution. Measurements were made using an XeCl excimer laser 12 emitting at 308 nanometres. The pulse repetition frequency was 10 Hz and the pulse duration around 20 nanoseconds. Such a pulse duration prevents the dopants within the specimen 10 from diffusing. These parameters correspond to the default settings of the laser 12.

The laser 12 had a beam 13 with a diameter of about 700 microns. The scanning employed had a pitch of around 350 micrometres and was such that each zone of the specimen 10 treated by the annealing was exposed once and advantageously three times to the beam 13 of the laser 12 during the scanning.

The specimens 10 subjected to this laser annealing operation had thicknesses of between about 200 and 500 nanometres.

Several experiments were carried out within several power density ranges. The repair was very satisfactory with power densities of between about 235 and 290 mJ/cm² for a specimen thickness of between about 300 and 500 nanometres since the defects due to the trapping of dopants deriving from the ion milling step disappeared. The defects are eliminated when energy coming from the laser is transferred to the specimen. The atoms of the crystalline semiconductor material and the ions of the dopant were repositioned in the crystal lattice.

The ions are located close to the amorphous layer at a depth of less than about 30 nanometres or in the amorphous layer. If ions of the same material as the semiconductor material are used, there are no impurities.

Higher power densities, up to about 880 mJ/cm², cause the semiconductor material to melt, making the characterization by electron microscopy impossible, while lower power densities result in overly incomplete repair.

Electron holography has been used for more than 20 years to analyse semiconductor specimens, likewise for focused ion beam milling in order to prepare specimens, but hitherto no satisfactory method of repairing specimens has been proposed.

### CITED DOCUMENTS

[1] “Improvement in electron holographic phase images of focussed-ion-beam-milled GaAs and Si p-n junctions by in situ annealing”, David Cooper et al., Applied Physics Letters, Vol. 88, 063510, 2006.
[2] “Transient annealing of semiconductors by laser, electron beam and radiant heating techniques”, A G Cullis, Rep. Prog. Phys., Vol. 48, pages 1155-1233, 1985.
[3] “Dopant redistribution and electrical activation in silicon following ultra-low energy boron implantation and excimer laser annealing”, S. Whelan et al., Physical Review B 67, 075201, 2003.
[4] “Laser assisted sample finish”, H. Ichinose et al., IMC16, Sapporo, 2006.
[5] JP-A-2005-172765.

1. Method of repairing crystal defects buried within a specimen (10) deriving from a semiconductor device, this specimen (10) having been prepared by the use of a focused ion beam that has caused said defects, wherein it consists in subjecting the specimen (10) to a laser annealing operation, the laser (12) having a power low enough not to melt the semiconductor material of the specimen (10) but high enough to eliminate the defects, and in that the power density of the laser (12) is between about 235 and 290 mJ/cm² for a specimen thickness greater than about 300 nm.

2. Method according to claim 1, wherein the laser (12) is an ultraviolet laser such as an excimer laser.

3. Method according to claim 1, wherein the laser (12) emits pulses with a repetition frequency of 10 Hz and a duration of about 20 ns.

4. Method according to claim 1, wherein the laser (12) has a beam (13) with a diameter of about 700 microns.

5. Method according to claim 4, wherein the laser (12) is made to undergo a scanning movement with a pitch of about 350 microns.

6. Method according to claim 5, wherein the laser (12) irradiates an area of the specimen three times during the scanning.
